(19) United States
(12) Patent Application Publication
(10) Pub. No.: US 2024/0070221 A1
(43) Pub. Date: Feb. 29, 2024

(54) METHODS AND SYSTEMS FOR GENERATING INTEGER NEURAL NETWORK FROM A FULL-PRECISION NEURAL NETWORK

(71) Applicant: Huawei Technologies Co., Ltd., Shenzhen (CN)

(72) Inventors: Eyyüb Hachmie SARI, Montreal (CA); Vanessa COURVILLE, Montreal (CA); Mohan LIU, Shanghai (CN); Vahid PARTOVI NIA, Montreal (CA)

(21) Appl. No.: 18/502,506

(22) Filed: Nov. 6, 2023

Related U.S. Application Data
(63) Continuation of application No. PCT/JP2022/018858, filed on Apr. 26, 2022.

(51) Int. Cl. G06F 17/12; G06F 7/50; G06F 7/523; G06F 7/544

(52) U.S. Cl. CPC G06F 17/12; G06F 7/50; G06F 7/523; G06F 7/5443

(57) ABSTRACT

Methods and systems for generating an integer neural network are described. The method includes receiving an input vector comprising a plurality of input values. The plurality of input values are represented using a desired number bits. The input vector is multiplied by a weight vector, and the products of which are summed to obtain a first value. The first value is quantized and applied to a piecewise linear activation function to obtain a second value. The piecewise linear activation function is a set of linear function that collectively approximate a nonlinear activation function. The second value is quantized to generate the output of the neuron in the integer neural network.

### CROSS-REFERENCE TO RELATED APPLICATIONS

The present disclosure is a continuation application of International Application No. PCT/CN2021/092792, entitled “METHODS AND SYSTEMS FOR GENERATING INTEGER NEURAL NETWORK FROM A FULL-PRECISION NEURAL NETWORK”, filed May 10, 2021, the entirety of which is hereby incorporated by reference.

### FIELD

The present disclosure relates to artificial neural networks, specifically methods and systems for generating an integer neural network from a full precision neural network.

### BACKGROUND

Artificial neural networks (NNs) are modelled on how biological brains operate. NNs are made up of a number of layers that each include a plurality of computational units (called neurons), with connections among computational units of different layers. Each neuron in a NN transforms data by performing a series of computations. The computations performed by each respective neuron includes a dot product computation that involves multiplying a set of input values by a respective set of weights and summing the products, adjusting the resulting number by a bias of the respective computational unit, and then applying a non-linear activation function to the adjusted number to generate an output value. The activation function ensures an output value that is passed on to a subsequent neuron within a tunable, expected range. The series of computations is repeated by the neurons of respective layers until a final output layer of the NN generates scores or predictions related to a particular inference task. NNs can perform inference tasks, such as object detection, image classification, clustering, voice recognition, or pattern recognition. NNs typically do not need to be programmed with any task-specific rules. Instead, NNs generally perform supervised learning to build knowledge from datasets where the right answer is provided in advance. An NN learns by iteratively tuning the weights and biases applied at its neurons until the NN can find the correct answer on its own.

NNs are commonly full precision NN's constructed using full-precision layers that are made up of full-precision computational units (e.g., full-precision neurons). Full-precision neurons perform NN computations, such as multiplication, addition, and normalization. NN computations in full-precision NNs are performed using tensors in which each element of each tensor is a real value (e.g. floating point number). As used in this disclosure, tensor can refer to an ordered data structure of elements in which the location of an element in the data structure has meaning. Examples of a tensor are a vector such as a row vector or column vector, a two dimensional matrix having multiple rows and columns of elements, a three dimensional matrix, and so on. In the case of a full-precision neuron, the set of input values to the full-precision neuron are typically arranged as elements of a feature vector and the set of weights applied by the computational unit are arranged as elements of a weight vector. In a full precision full-precision neuron, each element of each vector requires more than 8 bits to represent the floating point number (e.g., the individual elements in a input feature vector are each real values represented using 8 or more bits, and the parameters of the computational unit, such as weights included in a weight vector, are also real values represented using 8 or more bits). Because each value in each vector is represented using a floating point number, the NN computations performed by a full-precision neuron are computationally intensive. This places constraints on the use of full-precision NN's in computationally constrained hardware devices.

Accordingly, there is a growing interest in methods and systems that may reduce the number of NN computations required to be performed by a NN configured for a particular inference task and thereby enable NNs to be deployed in computationally constrained hardware devices. For example, computationally constrained hardware devices may employ less powerful processing units, less powerful (or no) accelerators, less memory and/or consume less power than more powerful hardware devices that are typically required for deployment of NNs. Reducing the number of NN computations may allow the NN, for example, to be deployed and executed on cost-effective computationally constrained hardware devices.

Accordingly, there is a need for systems and methods that reduce or eliminate the number of full-precision computations required by an NN and provide an acceptable inference accuracy.

### SUMMARY

The present disclosure provides methods and systems for an integer neural network that performs computations using integers rather than real values. Quantization is performed to convert real values of integer values that can be represented using on desired number of bits. Piecewise linear activation functions are applied instead of nonlinear activation functions. The use of quantized values and piecewise linear activation functions can provide an integer NN that can require fewer computational resources than a full-precision NN. For example, less computational operations may be required, less memory may be required and/or less power may be required to perform inference tasks.

According to an aspect of the present disclosure, a method for generating output of a neuron in an integer neural network is provided. The method includes receiving an input vector comprising a plurality of input values, the plurality of input values being represented using a desired number bits. Further, the method comprises multiplying the input vector by a weight vector to obtain products, which are summed to obtain a first value. The first value is quantized generating a quantized value, the quantized value being represented by the desired number of bits. The method further comprises applying a piecewise linear activation function to the quantized value to obtain a second value, the piecewise linear activation function including a set of linear functions that collectively approximate a nonlinear activation function. After obtaining the second value, the second value is quantized to generate the output of the neuron in the integer neural network. The output of the neuron is represented using the desired number of bits.

The set of linear functions that collectively approximate a nonlinear activation function may be generated by first receiving a desired number of piecewise segments to represent the nonlinear activation function. Then, the method may generate input data using the desired number of bits and output data by applying the input data to the nonlinear activation function. The output data is quantized to obtain quantized output data, with each input data and corresponding quantized output data being processed as respective input and output data pair. Iteratively, until a number of piecewise segments is equal to the desired number of piecewise segments, the method may determine piecewise segments. Each piecewise segment corresponds to a displacement line connecting a first input and output data pair to a subsequent second input and output data pair. Then, the method computes a slope of each piecewise segment and determines two adjacent piecewise segments with a minimum absolute distance between respective slopes. Further, the method may remove a shared input and output data pair of the two adjacent piecewise segments with the minimum absolute distance between respective slopes. Once the iterations are completed, the method may determine a linear function for each remaining piecewise segment, the linear functions of the remaining piecewise segments being the set of linear functions collectively approximating the nonlinear activation function.

The generated input data may include a set of all integer values between 0 and 2ⁿ^{_{bits}}−1. n_{bits} is the number of desired bits. In another aspect, quantizing the first value and the second value in a range of values between [a, b] is determined by computing:

$${s}_{m} = \frac{b - a}{{2}^{{n}_{bits}} - 1}$$

$${Z}_{m} = round ( \frac{- a}{{s}_{m}} )$$

$$q ( m ) = round ( \frac{m}{{S}_{m}} + {Z}_{m} )$$

where m is the first value or the second value, depending on whether the quantization is being determined for the first value or the second value, respectively, round(⋅) is the round-to-nearest integer function, and n_{bits} is the desired number of bits.

The range of values between [a, b] may be determined from a plurality of first values or a plurality of second values of a plurality of neurons in the integer neural network, depending on whether the quantization is determined for the first value or the second value.

The second value, determined by applying the piecewise linear activation function to the quantized value, may be computed using:

$${f}_{pwl} ( x ) = {\sum }_{i = 1}^{N} {b}_{i} + {{a}_{i} ( x - {k}_{i} )}_{+} where$$

$${( x - {k}_{i} )}_{+} = \{ \begin{matrix}0 , & if x < {k}_{i} \\ x - {k}_{i} , & if x \geq {k}_{i}\end{matrix}$$

where f_{pwl}(⋅) is the piecewise linear activation function representing the set of linear functions, N is the number of linear functions, each linear function representing respective piecewise segment, aᵢ is a slope, kᵢ is a piecewise linear knot, and bᵢ is an intercept of the i-th piecewise segment.

The piecewise linear activation function to approximate a nonlinear activation function may be generated during training of the integer neural network. Training the integer neural network may be performed until meeting a first criterion. Further, the method may approximate the nonlinear activation function with the piecewise linear activation function and replace the nonlinear activation function with the piecewise linear activation function. Lastly, the method may fine-tune the integer neural network implementing the piecewise linear activation functions until meeting a second criterion.

The method may further comprises normalizing the first data by computing using:

$$\hat{x} = \frac{1}{MAD std} ( x - μ )$$

where \hat{x} is a normalized value x, x is the first data, MAD std is the mean absolute deviation approximating a standard deviation of the first data, and μ is a mean value for the first data, MAD std and μ may be computed from a plurality of first data using the following:

$$μ = \frac{1}{m} {\sum }_{i = 1}^{m} {x}_{i}$$

$$MAD std = \frac{1}{m} {\sum }_{i = 1}^{m} \vert {x}_{i} - μ \vert$$

m is a number of first data in the plurality of first data, and |⋅| is the L1 norm.

The MAD std and μ may be computed from a plurality of first data during training of the integer neural network. The neuron of the integer neural network may be implemented in a long short-term memory of a recurrent neural network.

According to another aspect of the present disclosure, there is provided a system for generating output of a neuron in an integer neural network, the system comprising a processor, and a memory storing instructions which, when executed by the processor device, cause the system to receive an input vector comprising a plurality of input values. The plurality of input values being represented using a desired number bits. Further, the memory storing instructions which, when executed by the processor device, cause the system to multiply the input vector by a weight vector to obtain products, which are summed to obtain a first value. The first value is quantized generating a quantized value, the quantized value being represented by the desired number of bits. The memory storing further instructions which, when executed by the processor device, cause the system to apply a piecewise linear activation function to the quantized value to obtain a second value, the piecewise linear activation function including a set of linear functions that collectively approximate a nonlinear activation function. After obtaining the second value, the second value is quantized to generate the output of the neuron in the integer neural network. The output of the neuron is represented using the desired number of bits.

The set of linear functions that collectively approximate a nonlinear activation function may be generated by first receiving a desired number of piecewise segments to represent the nonlinear activation function. Then, the system generates input data using the desired number of bits and output data by applying the input data to the nonlinear activation function. The output data is quantized to obtain quantized output data, with each input data and corresponding quantized output data being processed as respective input and output data pair. Iteratively, until a number of piecewise segments is equal to the desired number of piecewise segments, the system determines piecewise segments. Each piecewise segment corresponds to a displacement line connecting a first input and output data pair to a subsequent second input and output data pair. Then, the system computes a slope of each piecewise segment and determines two adjacent piecewise segments with a minimum absolute distance between respective slopes. Further, the system removes a shared input and output data pair of the two adjacent piecewise segments with the minimum absolute distance between respective slopes. Once the iterations are completed, the system determines a linear function for each remaining piecewise segment, the linear functions of the remaining piecewise segments being the set of linear functions collectively approximating the nonlinear activation function.

The generated input data may include a set of all integer values between 0 and 2ⁿ^{_{bits}}−1. n_{bits} is the number of desired bits. Quantizing the first value and the second value in a range of values between [a, b] may be determined by computing:

$${s}_{m} = \frac{b - a}{{2}^{{n}_{bits}} - 1}$$

$${Z}_{m} = round ( \frac{- a}{{s}_{m}} )$$

$$q ( m ) = round ( \frac{m}{{S}_{m}} + {Z}_{m} )$$

where m is the first value or the second value, depending on whether the quantization is being determined for the first value or the second value, respectively, round(⋅) is the round-to-nearest integer function, and n_{bits} is the desired number of bits.

The range of values between [a, b] may be determined from a plurality of first values or a plurality of second values of a plurality of neurons in the integer neural network, depending on whether the quantization is determined for the first value or the second value.

The second value may be determined by applying the piecewise linear activation function to the quantized value, and may be computed by using:

$${f}_{pwl} ( x ) = {\sum }_{i = 1}^{N} {b}_{i} + {{a}_{i} ( x - {k}_{i} )}_{+} where$$

$${( x - {k}_{i} )}_{+} = \{ \begin{matrix}0 , & if x < {k}_{i} \\ x - {k}_{i} , & if x \geq {k}_{i}\end{matrix}$$

where f_{pwl}(⋅) is the piecewise linear activation function representing the set of linear functions, N is the number of linear functions, each linear function representing respective piecewise segment, aᵢ is a slope, kᵢ is a piecewise linear knot, and bᵢ is an intercept of the i-th piecewise segment.

The piecewise linear activation function used to approximate a nonlinear activation function may be generated during training of the integer neural network. Training the integer neural network comprises training the integer neural network implementing the nonlinear activation function until meeting a first criterion. Further, the system approximates the nonlinear activation function with the piecewise linear activation function and replaces the nonlinear activation function with the piecewise linear activation function. Lastly, the system fine-tunes the integer neural network implementing the piecewise activation functions until meeting a second criterion.

The system may further comprise normalizing the first data by computing:

$$\hat{x} = \frac{1}{MAD std} ( x - μ )$$

where \hat{x} is a normalized value x, x is the first data, MAD std is the mean absolute deviation approximating a standard deviation of the first data, and μ is a mean value for the first data, MAD std and μ being computed from a plurality of first data as in the following equations.

$$μ = \frac{1}{m} {\sum }_{i = 1}^{m} {x}_{i}$$

$$MAD std = \frac{1}{m} {\sum }_{i = 1}^{m} \vert {x}_{i} - μ \vert$$

m is a number of first data in the plurality of first data, and |⋅| is the L1 norm.

In a further aspect, MAD std and μ are computed from a plurality of first data during training of the integer neural network. In another aspect, the neuron of the integer neural network is used in a long short-term memory of a recurrent neural network.

According to another example aspect, the present disclosure describes a non-transitory computer-readable medium including instructions which, when executed by a processing device of a processing system cause the processing system to perform any of the preceding example methods.

According to another example aspect, the present disclosure describes a computer program comprising instructions which, when executed by a processing device of a processing system cause the processing system to perform any of the preceding example methods.

According to another example aspect, the present disclosure

describes a processing system including means for carrying out any of the preceding example methods.

### BRIEF DESCRIPTION OF THE DRAWINGS

Reference will now be made, by way of example, to the accompanying drawings, which show example embodiments of the present application, and in which:

FIG. 1 is a block diagram of a simplified processing system which may be part of a system used to implement an integer NN, in accordance with an example embodiment;

FIG. 2 is a schematic diagram illustrating the structure of and data flow in an integer NN, in accordance with an example embodiment;

FIG. 3 is a schematic diagram showing an example configuration of layers of an integer NN, in accordance with an example embodiment;

FIG. 4 is a schematic diagram of a neuron of a layer of an integer NN, in accordance with an example embodiment;

FIG. 5 is an example nonlinear activation function approximated with a piecewise linear activation function of three segments, in accordance with an example embodiment;

FIG. 6 is a flowchart of a method of training an integer NN, in accordance with an example embodiment;

FIG. 7A is a flowchart of a method for generating a nonlinear activation function that approximates a piecewise linear activation function, in accordance with an example embodiment;

FIGS. 7B(i)-7B(v) are graphs illustrating the method of FIG. 7A, in accordance with an example embodiment;

FIGS. 8A-8D are illustrative examples of a nonlinear activation function approximated with a piecewise linear activation function with different numbers of piecewise segments, in accordance with an example embodiment;

FIG. 9A is a schematic diagram of a long short-term memory (LSTM) recurrent neural network (RNN) architecture, in accordance with an example embodiment;

FIG. 9B is a schematic diagram of a trained LSTM cell of the LSTM RNN of FIG. 9A, in accordance with an example embodiment;

FIG. 9C is another schematic diagram of a trained LSTM cell of the LSTM RNN of FIG. 9A, including a normalizer, in accordance with an example embodiment;

Similar reference numerals may have been used in different figures to denote similar components.

### DESCRIPTION OF EXAMPLE EMBODIMENTS

Methods and systems for generating an integer neural network (NN) that approximates a full-precision NN are disclosed. The integer NN can require a fewer number of computations than a respective full-precision NN configured for the same inference task. In example embodiments, an integer NN is disclosed that applies quantization and normalization techniques in combination with piecewise linear activation functions that are used to approximate non-linear activation functions.

In this disclosure, reference is generally made to an integer NN that comprises an input layer, a plurality of intermediate layers, and an output layer; however, the examples disclosed herein may be implemented for a larger deep neural network. Each intermediate layer and output layer includes a plurality of neurons, and each neuron is a computational unit that comprises a multiplication block, at least one quantizer block, a summation block and an activation function block. The examples may be applicable for NNs that perform various tasks, including object classification, object detection, semantic segmentation, gesture recognition, action recognition, speech recognition, biometrics, and other tasks where a NN may be used.

Typically, an integer NN is trained for a particular inference task and, after being trained, the integer NN performs the particular inference task. Example embodiments describe a simple integer NN. Other example embodiments describe a specific integer NN type, integer version of long short-term memory (LSTM) recurrent NN (RNN). However, it will be appreciated that the methods and systems described herein are applicable to various full-precision NN types to perform a variety of inference tasks using supervised or unsupervised learning. It will also be appreciated that the methods and systems described are also applicable to various machine learning applications, specifically ones that require normalization and implement nonlinear functions.

The methods and systems may include quantizing data and/or parameters based on a specified number of bits. Quantization is performed, through a quantizer, for data comprising input data to the integer NN, output data of the integer NN, input data representation to layers of the integers NN, output data representation of layers of the integer NN, and NN parameters such as weights and biases. The methods and systems may also include data normalization. Normalization is applied to input data representation to intermediate layers of the integer NN. Example embodiments may disclose normalization being applied to other data, such as data within each neuron of the integer NN. The normalizer normalizes data by applying an equation for calculating the mean and the mean absolute deviation (MAD), which approximates the standard deviation of the data.

The neuron includes an activation function. The activation function of the integer NN is a piecewise linear activation function, which is used for making inferences. The piecewise linear activation function is generated to approximate a nonlinear activation function during the integer NN training. Approximation of the nonlinear activation function as the piecewise linear activation function includes replacing the nonlinear activation function of a full-precision NN with a desired number of piecewise segments that collectively represent the nonlinear activation function.

During training of the integer NN, piecewise function input data is provided to the nonlinear activation function to generate the nonlinear activation function output data, with the piecewise function input data and the nonlinear activation function output data being processed as respective input and output data pairs. Each piecewise segment corresponds to a displacement line connecting one input and output data pair to the subsequent input and output data pair. When the number of piecewise segments is less than or equal to the desired number of segments, the linear functions for the piecewise segments collectively provide a piecewise linear activation function approximation of the nonlinear activation function, which can be used when making inferences. If the number of piecewise segments is not less than or equal to the desired number of segments, the piecewise segments correspond to a preliminary piecewise linear activation function.

The preliminary piecewise linear activation function can be further simplified by determining the two adjacent piecewise segments with the minimum absolute distance between respective slopes. The input and output data pair shared between the adjacent piecewise segments with the minimum absolute distance can be removed and the slope between the non-shared input and output data pairs at the non-connecting ends of the adjacent piecewise segments can be computed. The two adjacent piecewise segments with minimum absolute distance between their slopes are combined into one piecewise segment. The combining of adjacent piecewise segments having the smallest slope differentials continues until the number of piecewise segments is less than or equal to the desired number of piecewise segments. The piecewise linear activation function approximating the nonlinear activation function can then be determined by combing the linear functions for each of the remaining piecewise segments in the preliminary piecewise linear activation function, which can be used when making inferences.

Once the piecewise linear activation function approximating the nonlinear function is determined, the nonlinear activation function of the integer NN is replaced with the piecewise linear activation function. Replacing nonlinear activation function with a piecewise linear activation function is performed during the integer NN training. Initially, the integer NN training may begin with a nonlinear activation function. When the integer NN training stabilizes, the piecewise linear activation function generation, described above, begins. Training of the integer NN continues to fine-tune the learnable parameters of integer NN (i.e. weights and biases of each layer). Using the piecewise linear activation function instead of the nonlinear activation function reduces the number of NN operations required during inference making, enabling simplified calculations and decreasing computation time.

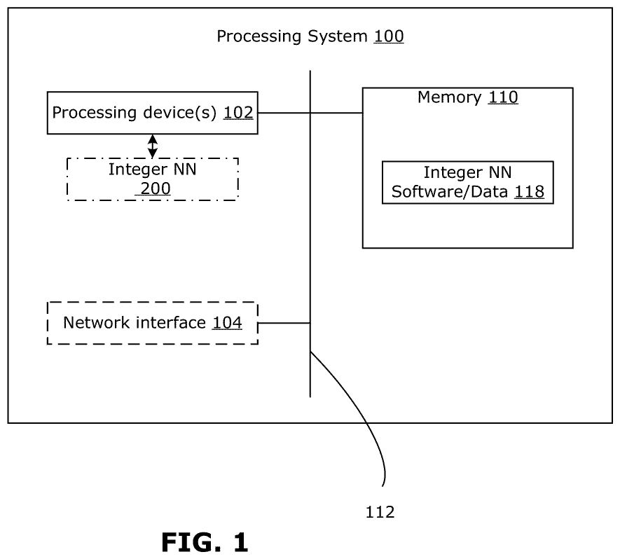

FIG. 1 is a block diagram of an example processing system 100, which may be part of a system used to implement an integer NN which performs a particular inference task. Other processing systems suitable for implementing embodiments described in the present disclosure may be used, which may include components different from those discussed below. Although FIG. 1 shows a single instance of each component, there may be multiple instances of each component in the processing system 100.

The processing system 100 may include one or more processing devices 102, such as a processor, a microprocessor, a Neural Processing Unit (NPU), a tensor processing unit (TPU), a graphics processing unit (GPU), a hardware accelerator, an application-specific integrated circuit (ASIC), a field-programmable gate array (FPGA), or combinations thereof.

The processing system 100 may include one or more optional network interfaces 104 for wired (e.g. Ethernet cable) or wireless communication (e.g. one or more antennas) with a network (e.g., an intranet, the Internet, a P2P network, a WAN and/or a LAN).

The processing system 100 may also include one or more memories 110, which may include volatile and/or non-volatile memory (e.g., a flash memory, a random access memory (RAM), and/or a read-only memory (ROM)). The non-transitory memory(ies) 110 may store software instructions and data 118 that configure the one or more processing device(s) 102 to implement an integer NN 200. The integer NN software and data 118 may include machine-learning based software, libraries and configuration data (e.g., NN parameters including weights, biases, and hyper-parameters) that can be executed and/or used by the one or more processing devices 102 to implement routines, subroutines, algorithms and equations required to implement integer NN 200.

In some examples, memories 110 may also include software and data required for training the integer NN 200. One or more datasets used to train the integer NN 200 may be provided by an external memory (e.g., an external drive in wired or wireless communication with the processing system 100) or may be provided by a transitory or non-transitory computer-readable medium. Examples of non-transitory computer-readable media include a RAM, a ROM, an erasable programmable ROM (EPROM), an electrically erasable programmable ROM (EEPROM), a flash memory, a CD-ROM, or other portable memory storage.

There may be a bus 112 providing communication among components of the processing system 100, including the processing device(s) 102, network interface(s) 106, and/or memory(ies) 110. The bus 112 may be any suitable bus architecture, including, for example, a memory bus, a peripheral bus or a video bus.

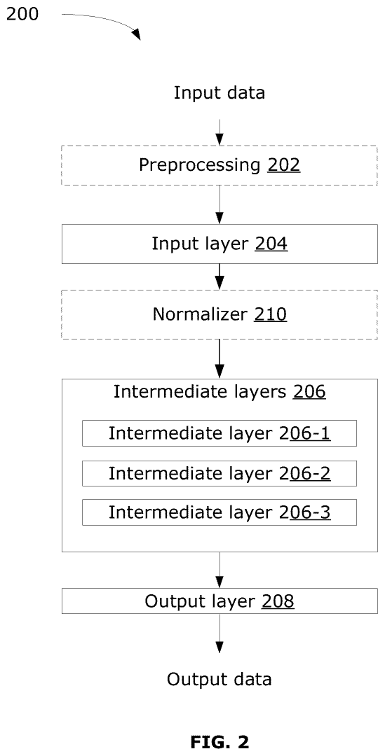

FIG. 2 is a schematic diagram illustrating an example structure of and data flow of an integer NN 200. Optional elements in FIG. 2 are shown in dashed lines. The integer NN 200 has been simplified and is not intended to be limiting and is provided for illustration only. The integer NN 200 of FIG. 2 is an example of an integer NN that can be trained to make inferences (i.e. predictions). The input data to the NN 200 may be, for example, image data, video data, audio data, or text data. The integer NN 200 may optionally include a preprocessing block 202, which may perform various operations to prepare the input data for the input layer 204. The integer NN 200 comprises a number of layers including the input layer 204, a plurality of intermediate layers 206 (including, for example intermediate layers 206-1, 206-2, and 206-3), and an output layer 208. Each of the layers 204, 206, 208 is a grouping of one or more neurons that are independent of each other, allowing for parallel computing. The neurons and their structure are further explained in detail below. The integer NN 200 may also include a normalizer 210. The input layer 204 receives the processed data from the optional preprocessing 202.

The pre-processed data from the input layer 204 are input to the normalizer 210 for normalization, and the output of the normalizer 210 is input to a plurality of intermediate layers 206. The first intermediate layer 206-1 receives the normalized data output from the normalizer 210, processes the input from the input layer 204, and outputs a first output data representation, which is input to the intermediate layer 206-2. The intermediate layer 206-2 receives the first output data representation, processes the first output data representation, and outputs a second output data representation, which is input to the intermediate layer 206-3. The intermediate layer 206-3 operates similar to the intermediate layer 206-1 and the intermediate layer 206-2. The output layer 208 follows the plurality of intermediate layers 206. The output layer 208 receives a third output data representation from the intermediate layer 206-3, processes the third output data representation to generates logits, and output predictions for which the integer NN is trained to predict. Logits are unprocessed predictions of integer NN 200. The output layer 208 passes the logits into a function, such as a softmax function, to transform the logits into probabilities. The output layer 208 is a final layer in the integer NN 200.

While the output layer 208 of this example embodiment processes the third output data representation from the intermediate layer 206-3 to generate logits then passes the logits into a function, example embodiments may describe the output layer 208 as a function that transforms the third output data representation into probabilities.

### Normalization

Data normalization helps the network converge faster during training. The normalization process, which is now explained, is optional and performed by the normalizer 210. Data normalization is a process of changing data into a common scale. In this example embodiment, normalizer 210 receives the pre-processed data from input layer 204 and outputs normalized data. The normalizer 210 may be applied once or more to data at various stages of the integer NN 200. This example shows the normalizer 210 being applied to the output of the input layer 204, which is the pre-processed data. In other example embodiments, normalizer 210 could be applied between intermediate layers 206 or after intermediate layers 206. In example embodiments, the operations of normalizer 210 are distributed and applied at each neuron.

The normalizer 210 normalizes the output of the input layer 204, which is the pre-processed data, by computing equation (1) below.

$$\hat{x} = \frac{1}{M A D s t d} ( x - μ ) \qquad ( 1 )$$

Where x is the pre-processed data to be normalized, μ is a mean vector, MAD std is a MAD standard deviation vector. MAD std approximates the standard deviation of the pre-processed data. μ and MAD std of equation (1) may be computed and stored in memory 110 during training of the integer NN 200 as in equations (2) and (3) below.

$$μ = \frac{1}{m} {\sum }_{i = 1}^{m} {x}_{i} \qquad ( 2 )$$

$$MADstd = \frac{1}{m} {\sum }_{i = 1}^{m} \vert {x}_{i} - μ \vert \qquad ( 3 )$$

where m is the number of preprocessed data to compute μ and MAD std from, and |⋅| is the L1 norm. The stored μ and MAD std may be used by the normalizer 210 during inference making to compute equation (1).

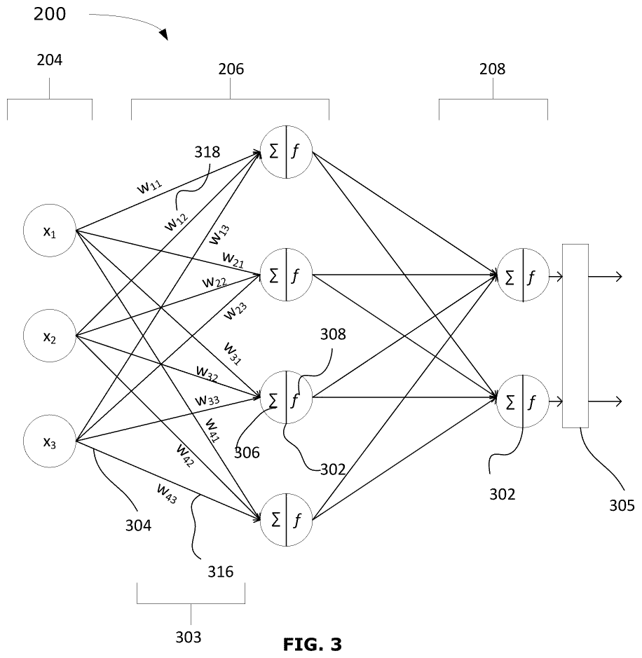

FIG. 3 is a schematic diagram showing an example configuration of an integer NN 200, simplified to show only a single intermediate layer 206. The integer NN 300 comprises groups of neurons arranged in a plurality layers, comprising input layer 204, intermediate layer 206, and output layer 208.

In the illustrated example of FIG. 3, the NN layers are fully connected such that the output of each neuron in a given layer is connected to the input of all neurons 302 in a subsequent layer, as indicated by connections 304 (one of which is labelled in FIG. 3). In the intermediate and final layers 206, 208, each neuron 302 is a logical programming unit that includes a multiplication operation 303 that applies respective weights to each of the neuron inputs, a summation operation 306 for summing the weighted inputs and applying a bias, and an activation function 308, for transforming or manipulating the summed, weighted inputs. As described in greater detail below, neurons 302 also include first and second quantizers. The outputs of all neurons 302 of the intermediate layer 206 can collectively be referred to as the output data representation of the intermediate layer 206. The activation function (f) 308 of each neuron 302 results in a particular output in response to the particular input(s), weight(s) and bias(es) of the neuron 302. In example embodiments, the activation function 308 implements a piecewise linear activation function 308, which is a set of linear activation functions that collectively approximates a nonlinear activation function. The activation function 308 ensures that values passed on to a subsequent NN layer are within a tunable, expected range. Each neuron 302 may store its respective activation function, weights (if any) and biases (if any) independent of other neurons 302.

The output layer 208 is followed by a further function 305, such as a softmax function. The output of all neurons 302 of the output layer 208 are called logits and are passed through the function 305, which transforms the logits into probabilities used for decision making when making inferences or calculating losses when training the integer NN 200.

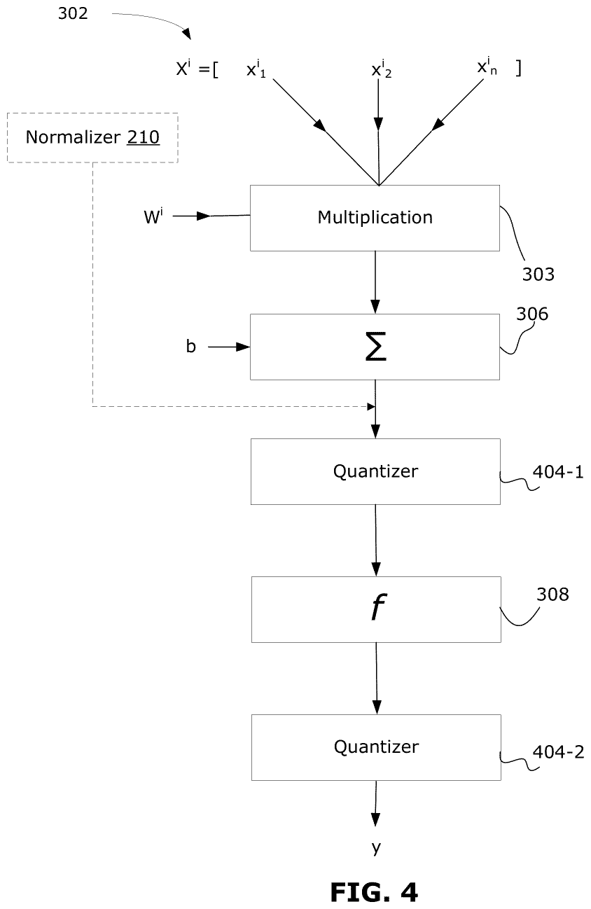

FIG. 4 is a schematic diagram of an example neuron 302 of an integer NN 200. As noted above, neuron 302 includes a set of successive operations, including multiplication operation 303, summation operation (Σ) 306, and an activation function (f) 308. Additionally, neuron 302 includes a first quantizer 404-1 that precedes activation function (f) 308, and a second quantizer 404-2 that follows activation function (f) 308. The output of a neuron 302 can be mathematically represented by equation (4).

y=q(f(q(WⁱXⁱ+b))) (4)
where Xⁱ=[x₁ⁱ, x₂ⁱ, . . . xₙⁱ] is a vector (e.g., an 8, 16, 32, or 64-bit vector) of inputs 316, to the neuron 302. Each input value is x₁, x₂, . . . , xₙ is a scaler value. Wⁱ is a weight vector for a neuron 302-i, including a respective weight for each input value of vector Xⁱ. This example embodiment shows that there is a weight value 318 applied to the output of every neuron 302 in the input layer 310 to every neuron 302 in the intermediate layer 312. The subscript of the weight 318 describes the source neuron 302 and the destination neuron of the weight. For example, w₁₂ means the weight from (source) neuron 2 in layer 1 to (destination) neuron 1 in layer 2. The weight vector of a layer (Wⁱ) includes all the weights of the destination neuron 302. For example, the weight vector (Wⁱ) for the neuron labelled 302 includes [w₄₁, w₄₂, w₄₃]. In equation 4, q(⋅) is the quantization operation performed by quantizer 404-1 and 404-2 (discussed in detail below). The output y comprises a single scaler value 304 passed as input value to neurons 302 of the subsequent layer.

Multiplication operation 303 performs vector multiplication of the input vector Xⁱ=[x₂ⁱ, x₂ⁱ, . . . xₙⁱ] with weight vector Wⁱ=[w₁ⁱ, w₂ⁱ, . . . wₙⁱ]. The outputs included in the resulting vector are summed together and adjusted by a bias b at the summation operation (Σ) 306. Collectively, the multiplication operation and summation operation can be performed as a dot-product multiplication operation.

The value generated by summation operation 306 may be a value that requires more bits to represent it than a desired number of bits. Hence, the quantizer 404-1 is configured to ensure that the output of the summation operation 306 is represented with the desired number of bits and is an integer value. The output of the quantizer 404-1 is provided to activation function 308 (described in detail below), the output of which is further quantized by the quantizer 404-2. The output of the quantizer 404-2 is the output y of the neuron 302. The neuron output y is provided to the neurons of the subsequent layer if the neuron 302 is part of an intermediate layer 206 or to the function 305 if the neuron 302 is part of an output layer 208.

Equation 4, as described above, describes operation of a single neuron 302 in of a plurality of neurons in an intermediate layer 206 or an output layer 208. As known in the art, in an actual implementation, the multiplication computations corresponding to several neurons of layer are typically combined into a single matrix multiplication (matmul) operation. The variables of Equation 4 can be modified to describe operation of a fully connected layer 206 or 208 of NN 200, or operation of a filter in a convolution layer. For example, as neurons 302 are independent of other neurons 302, the same operations for a single neuron 302 can be applied to a layer of neurons 302 (e.g. intermediate layer 312) at the same time. The modified variables to equation (4) to represent parallel operation of neurons of an NN layer rather than a single neuron 302 include: The input Xⁱ is a matrix of inputs to all neurons 302 of a layer i (intermediate layer 206 or ouput layer 208). Also, the weights Wⁱ may be represented by a matrix of all weights of all neurons 302 of the layer i. The bias b, may be a vector of biases for each neuron 302 of layer i, being represented as bⁱ. Multiplication operation 303 can be a matmul operation. Quantizer 404-1 and 404-2, summation 306, and activation functions 308 are similarly applied to all neurons 302 in the layer i.

### Quantization

The integer NN 200 operates and processes integer numbers, which allows the integer NN 200 to be implemented in fixed-point devices that do not support full-precision number. The integer feature of the integer NN 200 is achieved by the quantizers 404-1 and 404-2, which function to transform non-integer values into integer values that can be represented by a desired number of bits. Quantization is a compression technique that applies a process to discretize a continuous range of data to a given number of values using a linear transformation. Quantizing data may reduce computational cost significantly. For example, the memory requirements and number of computational operations that would typically be required to support multiply and summation operations may be substantially reduced, thereby enabling an integer NN to be deployed to constrained hardware devices that may have less powerful processors, less memory, and smaller power supplies. Hence, an integer NN may perform computation using integer values represented by a lower number of bits than corresponding real values in a full-precision NN. Manipulating integer values is significantly faster than real values and could be deployed onto low-cost devices that do not support full-precision.

The operation of quantizer 404-1 on the output of the summation operation 306 is now described. Given a desired number of bits n_{bits} desired to quantize the summation operation 306 output, the quantizer 404-1 quantizes the output to one of 2ⁿ^{_{bits}} levels. To obtain a quantized value q(m) of the summation 306 output, m, quantizer 404-1 calculates the step-size S and the zero-crossing value Z of the data m using equations (5)-(7) below. The summation 306 output, m, is in the range between [a, b],

$${S}_{m} = \frac{b - a}{{2}^{{n}_{bits}} - 1} \qquad ( 5 )$$

$${Z}_{m} = round ( \frac{- a}{{S}_{m}} ) \qquad ( 6 )$$

$$q ( m ) = round ( \frac{m}{{S}_{m}} + {Z}_{m} ) \qquad ( 7 )$$

where round(⋅) is the round-to-nearest integer function. The values of a and b describe the range of m. The range of m of a neuron 302 may be obtained and stored in memory 110 from a plurality of m values collected during training of the integer NN 200 or 300. The quantizer 404-1 output is q(m) as computed in equation (7) is provided to activation function 308. Quantizer 404-2 operates in an identical manner as quantizer 404-1 to quanitize the output of the activation function 308.

Example embodiments describe obtaining values a and b in equation (5), for the range of m, from a plurality of m values in other neurons of the same layer.

It is to be understood that in different example embodiments, the quantizers 404-1 and 404-2 can be applied at different stages other than at the output of summation operation 306 and the output of the activation function 308 to ensure data of the integer NN 200 are integers. In some examples, quantization may also be applied to the parameters. The data and parameters comprise input data to the integer NN, output data of the integer NN, input data representation to layers of the integers NN, output data representation of layers of the integer NN, and NN parameters such as weights and biases for each neuron 302.

### Activation Function

The quantized output from the quantizer 404-1 is passed to the activation function 308. As noted above, activation function 308 ensures that the values passed on to a subsequent layer are within a tunable, expected range. The neurons 302 of the integer NN 200 implement piecewise linear activation functions 308 approximating a nonlinear activation function, such as the sigmoid function, which is generally used in a full-precision NN. Processing the quantization output in the piecewise linear activation function 308 requires less number of computations than corresponding nonlinear activation functions.

Examples of piecewise activation functions 308 may be a binary step, rectified linear unit (ReLU), leaky ReLU, identity, randomized ReLU, which may be used in integer NN 200. Examples of non-linear activation functions that can be approximated using nonlinear activation functions are: sigmoid, step, tanh, swish, inverse square root unit (ISRU), soft plus, square non-linearity, inverse square root linear, exponential linear unit, and other types of nonlinear activation functions 308.

The neuron 302 may also include an optional normalizer 210 applied to the output of the summation operation 306. For the neuron 302, the computation of the output of the normalizer 210 can be computed as indicated in above equations (1) to (3), except that the variable x in equation (1) is a scaler value as opposed to a vector. The variable x is the output of the summation operation 306. Further, μ and MAD std may be computed for the neuron 302 during the training stage or when there is a plurality of x values to enable the computations described in equation (2) and (3).

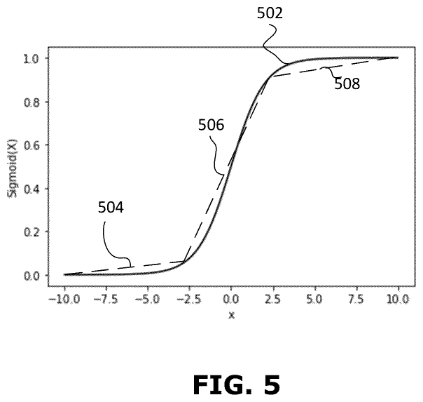

FIG. 5 is an illustrative graph depicting a nonlinear activation function, and a corresponding approximated piecewise linear activation function f_{pwl}, that includes three piecewise segments 504, 506, and 508, according to an example embodiment. The piecewise linear activation function is used as the activation function 308 of the integer NN 200 during inference making. The sigmoid function 502 is a nonlinear activation function that is formulated as

$$σ ( x ) = \frac{{e}^{x}}{{e}^{x} + 1} .$$

The piecewise linear activation function f_{pwl} approximates the nonlinear sigmoid function with three linear functions l(x) that respectively correspond to the piecewise segments (504, 506, 508). Each of the three linear functions has the form l(x)=ax+b, where a,b are the slope and the intercept of the corresponding piecewise segment, respectively. Using the piecewise linear activation function approximation of a nonlinear activation function can reduce number and complexity of performed by the processing device 102. For instance, instead of calculating exponents and divisions of a sigmoid function, the processing device 102 computes multiplications and additions needed for the piecewise linear activation function.

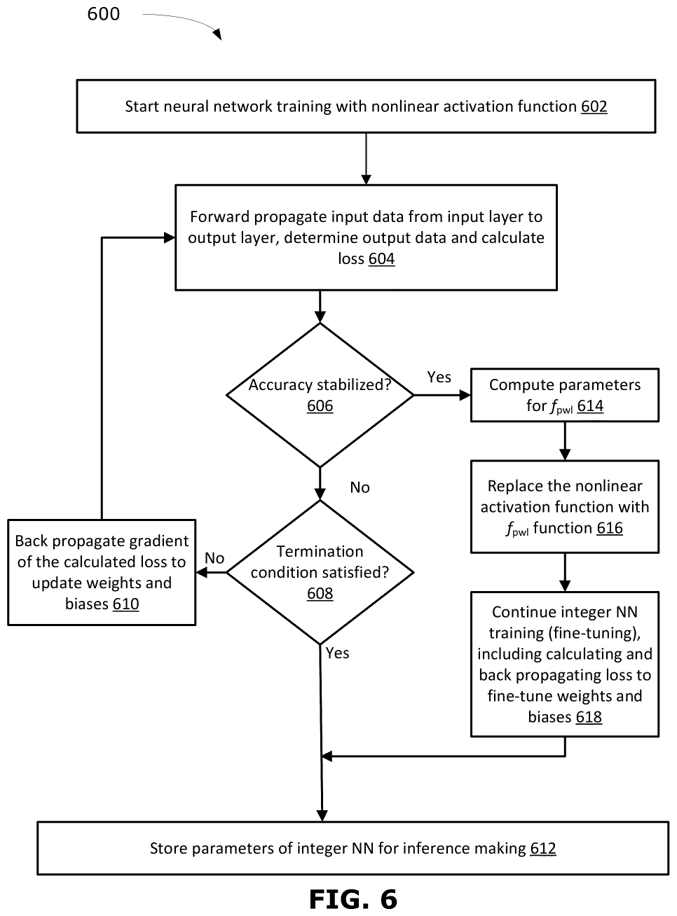

FIG. 6 is a flowchart of an example method explaining an integer NN training, according to an example embodiment of the present disclosure. Generally, training of an integer NN adjusts the values of the parameters of the integer NN 200, such as the values of the weights and biases. An example algorithm used to train the integer NN 200 is backpropagation. Backpropagation is used to adjust (also referred to as update) a value of a parameter (e.g., a weight) in the integer NN, so that an error (or loss) in the output of the integer NN 200 becomes smaller over a number of training iterations. For example, a defined loss function, such as minimum square error (MSE), is calculated based on the forward propagation of an input data to an output data of the integer NN (200 or 300), and a gradient algorithm (e.g., gradient descent) is used to update the parameters to reduce the loss function. This process is done iteratively. With each iteration, the MSE decreases until the parameters of the integer NN 200 are optimized. After the integer NN 200 is trained, the weights and biases are fixed, and may be used in future real-time operations to predict output values, in other words, make inferences.

Training the integer NN 200 starts with one or more of the activation functions 308 implementing a nonlinear activation function at step 602. The training method described by flowchart 600 forward propagates the input data of the integer NN 200 to the output data using all the weights and biases assigned to the integer NN 200, and computes a loss 604. The loss may be MSE loss which compares the output data of the integer NN 200 with the desired output required to be achieved. A decision is then made as to whether the integer NN 200 has stabilized 606. Several methods can determine whether the integer NN has stabilized, one of which is determining when a specific number of training epochs have been completed. If the integer NN 200 has stabilized 606, a determination is made as to whether a training termination condition is satisfied that would halt training 608. Examples of termination conditions include reaching a pre-specified number of epochs. Once the termination condition is satisfied, training halts, and the integer NN 200 is trained. The parameters of the trained integer NN 200 represented by weights and biases of all neurons 302 may be stored and used to make future inferences (i.e. predictions) 612.

The number of epochs relates to a method of feeding input data to train the integer NN 200. The integer NN 200 is trained using a training dataset which is a set that includes a plurality of training data samples. Each data sample is an x, y tuple where x is input data of the training data sample and y is a ground-truth label. In each training iteration, a batch of the data samples is used to train the integer NN 200. The batch contains randomly sampled data samples from the training dataset. An epoch is achieved when the batches that trained the integer NN 200 included the full training dataset.

Example embodiments may describe the termination condition of training the integer NN 200 is met after iterating pre-specified number of iterations. Example embodiments may decide that the integer NN 200 or 300 has stabilized after iterating a pre-specified number of iterations.

In the case where the termination condition is not satisfied 608, a loss is computed and back propagated using a gradient algorithm to update weights and biases of all neurons 302 at block 610, and the training continues until the termination condition is satisfied. Backpropagation is an example, not intended to be limiting, and provided for illustration only. Other training methods may include difference target propagation, Hilbert-Schmidt Independence Criterion, online alternating minimization, and other methods.

If the case where accuracy has stabilized 606, parameters are computed to approximate the nonlinear activation function 308 with a piecewise linear activation function f_{pwl} 614, and the nonlinear activation function 308 are replaced with the piecewise linear activation function 308 at step 616. Further, the method 600 continues the integer NN 200 training at 618 with neurons 302 implementing piecewise linear activation functions 308 to fine-tune the NN parameters until a termination condition is satisfied, at which the training method 600 halts training and may use be used for inference making. At step 618, the fine-tuning includes calculating and back propagating the loss (MSE loss) using the gradient algorithm until meeting a termination condition.

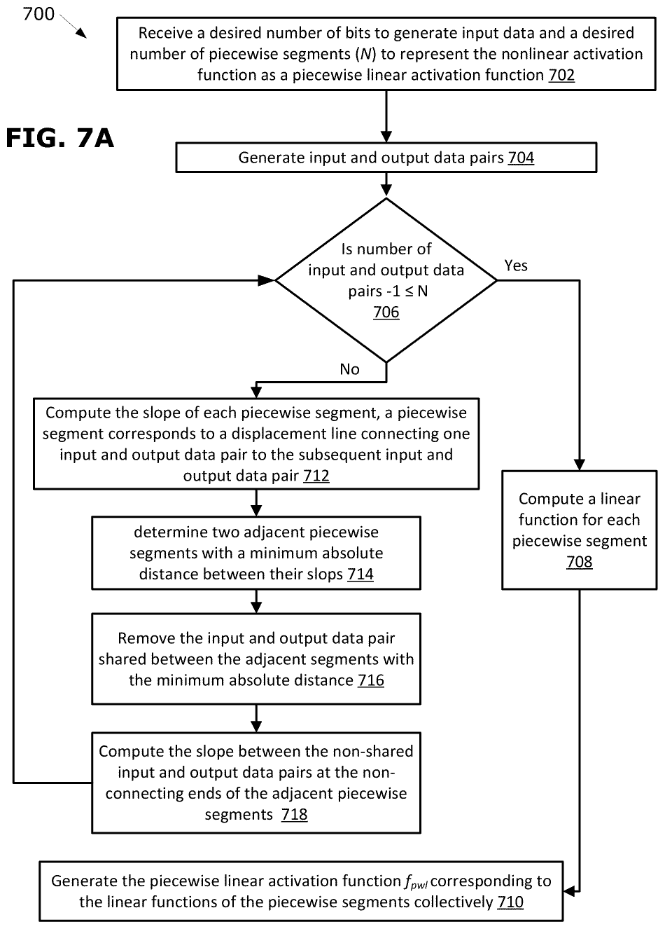

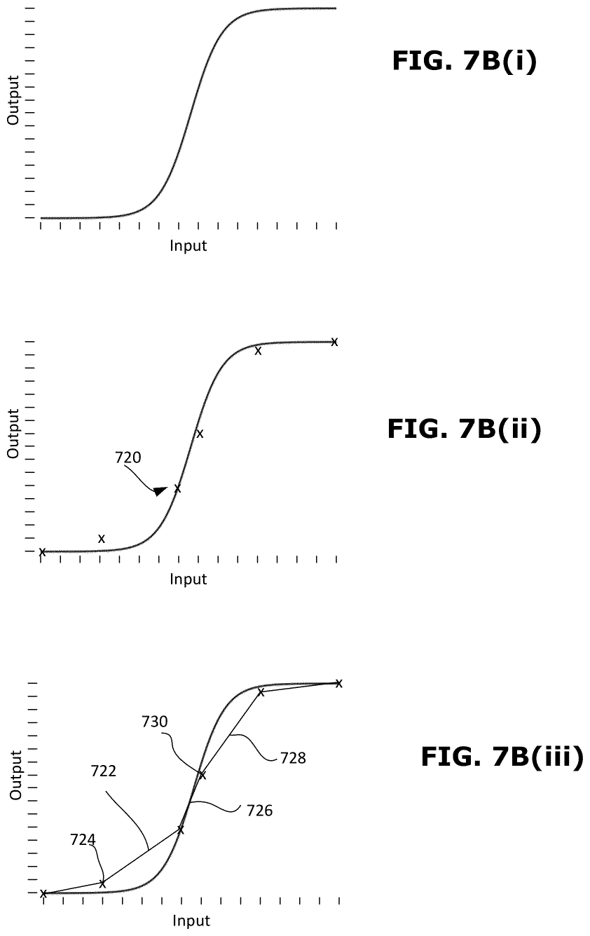

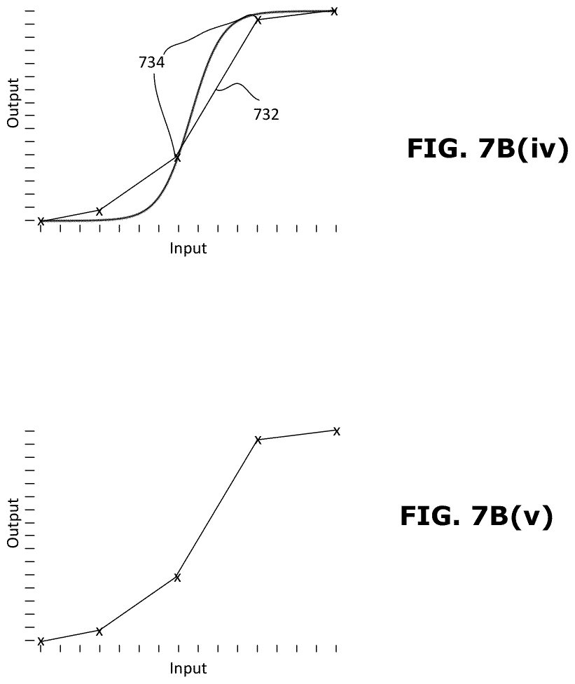

FIG. 7A is a flowchart of a piecewise linear activation function generation method 700 for approximating a nonlinear activation function 308 as a piecewise linear activation function, according to an example embodiment of the present disclosure. Method 700 corresponds to block 614 of FIG. 6. Before method 700 starts, the activation function 308 in a neuron 302 of the integer NN 200 and 300 is a nonlinear activation function, such as a sigmoid function, for which method 700 approximates a piecewise linear activation function for. The method 700 begins when the training accuracy of integer NN 200 has stabilized in the method 600 of FIG. 6.

The method 700 receives a desired number of bits (n_{bits}) to generate piecewise function input data and receives the number of desired piecewise segments (N) for approximating the nonlinear activation function at step 702. The desired number of bits (n_{bits}) is used in quantization block 404-1 and 404-2. The piecewise function input data is the 2ⁿ^{_{bits}} possible integer values i.e. the set of integer numbers between 0 and 2ⁿ^{_{bit}}⁻¹. The piecewise function input data is passed through the nonlinear activation function to generate a corresponding nonlinear activation function output data for each piecewise function input data 704. The piecewise function input data is of integer values, so it does not require quantization; however, the nonlinear activation function output data may not be of integer values since it is output of a nonlinear activation function. In some examples, the nonlinear activation function output data is quantized using equations (5)-(7) above. The piecewise function input data and the respective nonlinear function output data are processed and referred to as input and output data pairs.

Each piecewise segment corresponds to a displacement line connecting one input and output data pair to the subsequent input and output data pair. The linear functions for the piecewise segments collectively provide a piecewise linear activation function approximation of the nonlinear activation function.

The method 700 compares the number of piecewise segments between every two consecutive input and output data pairs to N. In other words, the method 700 compares the number of input and output data pairs minus 1 to N 706. If the number of input and output data pairs minus 1 to N is less than or equal to N, then the method 700 determines a linear function for every piecewise segment 708. The linear functions of the piecewise segments collectively represent the piecewise linear activation function f_{pwl} at step 710. The piecewise linear activation function f_{pwl} is represented as in equation (8) below.

$${f}_{p w l} ( x ) = {\sum }_{i = 1}^{N} {b}_{i} + {{a}_{i} ( x - {k}_{i} )}_{+} \qquad ( 8 )$$

$$where$$

$${( x - {k}_{i} )}_{+} = \{ \begin{matrix}0 , & if x < {k}_{i} \\ x - {k}_{i} , & if x \geq {k}_{i}\end{matrix}$$

x is a value for which the For each piecewise segment i of N desired piecewise segments, aᵢ is the slope, kᵢ is a piecewise linear knot, representing the x—axis coordinates of the start of the i-th piecewise segment, and bᵢ is the intercept of the i-th piecewise segment.

Suppose the number of input and output data pairs minus 1 to N is greater than N. In such case, the method 700 computes the slope of every piecewise segment (displacement line), and the piecewise segments correspond to piecewise segments of a preliminary piecewise linear activation function 712.

The preliminary piecewise linear activation function can be further simplified until the number of piecewise segments becomes less than or equal to the desired number of piecewise segments. The method 700 determine the two adjacent piecewise segments with the minimum absolute distance between their slops 714. The input and output data pair shared between the adjacent piecewise segments with the minimum absolute distance can be removed 716, and the slope between the non-shared input and output data pairs at the non-connecting ends of the adjacent piecewise segments can be computed 718. As a result, the two adjacent piecewise segments with minimum absolute distance between their slopes are combined into one piecewise segment connecting the non-shared input and output data pairs at the non-connecting ends.

The combining of adjacent piecewise segments having the smallest slope differentials continues until the number of piecewise segments is less than or equal to the desired number of piecewise segments. A final piecewise activation linear function approximating the nonlinear activation function can then be determined by computing and combining the linear functions for each of the remaining piecewise segments.

FIGS. 7B(i)-7B(v) provide an illustrative example of the piecewise linear activation function generation of four piecewise segments (N=4) using method 700 of FIG. 7A, according to example embodiments. FIG. 7B(i) illustrates a sigmoid nonlinear activation 308 to be approximated and replaced with a piecewise linear activation function f_{pwl} 308. FIG. 7B(ii) illustrates only six input and output data pairs, only one of which is labelled 720. The six input and output data pairs 720 correspond to five piecewise segments, only some of which is labelled at 722, 726, 728. These five piecewise segments 722, 726, 728 are linear, and each piecewise segment 722, 726, 728 can be formulated as a linear equation defined by its slope aᵢ and intercept bᵢ, where i is the segment number. For the piecewise segment at 722, i in equation (8) is equal to 2 because the piecewise segment at 722 is the second segment from the (0,0) Cartesian coordinates. The linear function of the piecewise segment 722, as in equation (8), has a slope value of a₂ and intercept b₂. The knot kᵢ of this segment, k₂, is the start of the piecewise segment as shown at 724.

The number of input and output data pairs minus 1 is 5, as illustrated in FIG. 7B(iii), which is more than N=4. Therefore, the method 700 computes the slope of every piecewise segment, and identify the two adjacent piecewise segments with the minimum absolute distance between their slopes as in steps 712 and 714 of the flowchart in FIG. 7A. In the present example, the third segment (i=3) 726, and the fourth segment (i=4) 728 have the minimum absolute distance between their slopes (i.e. between a₃ and a₄ of equation (8)). The method 700 removes the shared input and output data pair 730 as described in the flowchart of FIG. 7A at block 716.

FIG. 7B(iv) illustrates that the shared input and output data pair 730 of piecewise segments with the minimum absolute distance between their slops of FIG. 7B(iii) is removed, and segments i=3 and i=4 of FIG. 7B(iii) are replaced with a new piecewise segment 732. The new piecewise segment 732 corresponds to the displacement line between the input and output data pairs at 734, which corresponds to the non-shared input and output data pairs of the two piecewise segments with the minimum absolute distance between their slops (i.e. piecewise segments 726 and 728 in FIG. 7B(iii)). The total number of piecewise segments in FIG. 7B(iv) is 4. Since the number of input and output data pairs minus 1 is less than or equal to N, the method 700 computes a linear equation for every piecewise segment to generate piecewise linear activation function f_{pwl} described in equation (8) above. FIG. 7B(v) illustrates the piecewise linear activation function f_{pwl} 308 of the sigmoid nonlinear activation function 308.

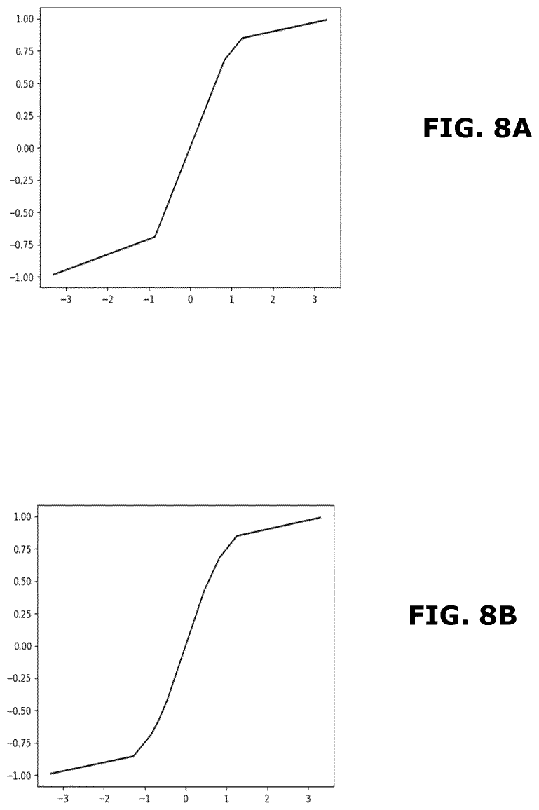

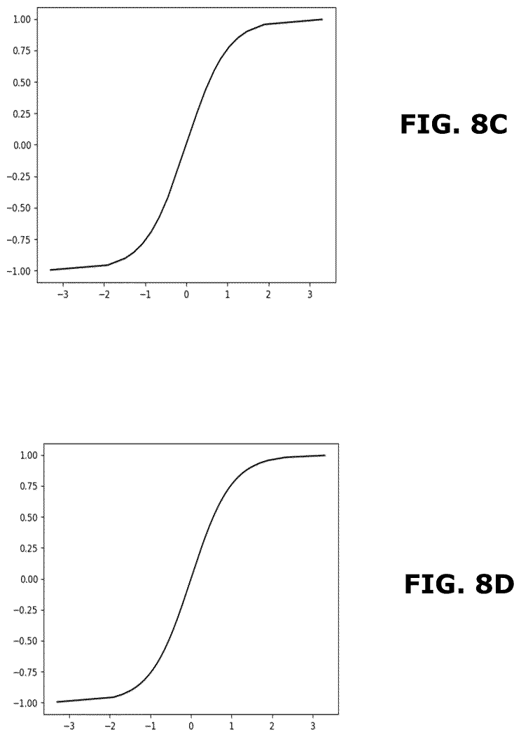

FIGS. 8A-8D illustrate examples of a piecewise linear activation functions approximating a nonlinear activation function with different numbers of desired piecewise segments. FIGS. 8A-8D show that the larger the number of piecewise segments, the more accurate the approximation is. The nonlinear activation function in FIGS. 8A-8D is the tanh function. FIG. 8A is for a piecewise linear activation function 308 with N=4, FIG. 8B is for a piecewise linear activation function 308 with N=8, FIG. 8C is for a piecewise linear activation function 308 with N=16, and FIG. 8D is for a piecewise linear activation function 308 with N=32.

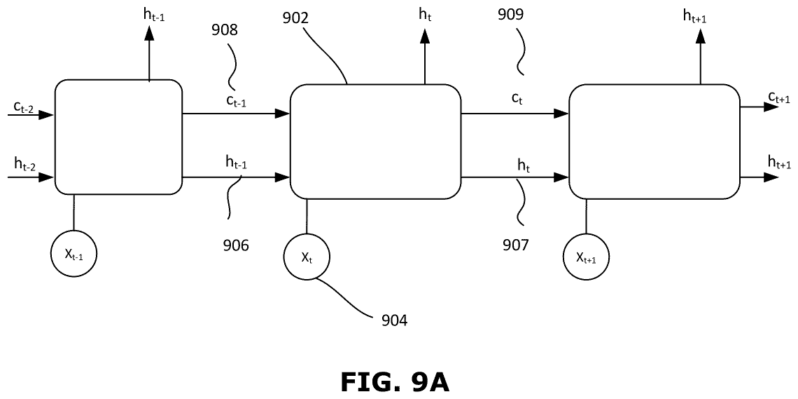

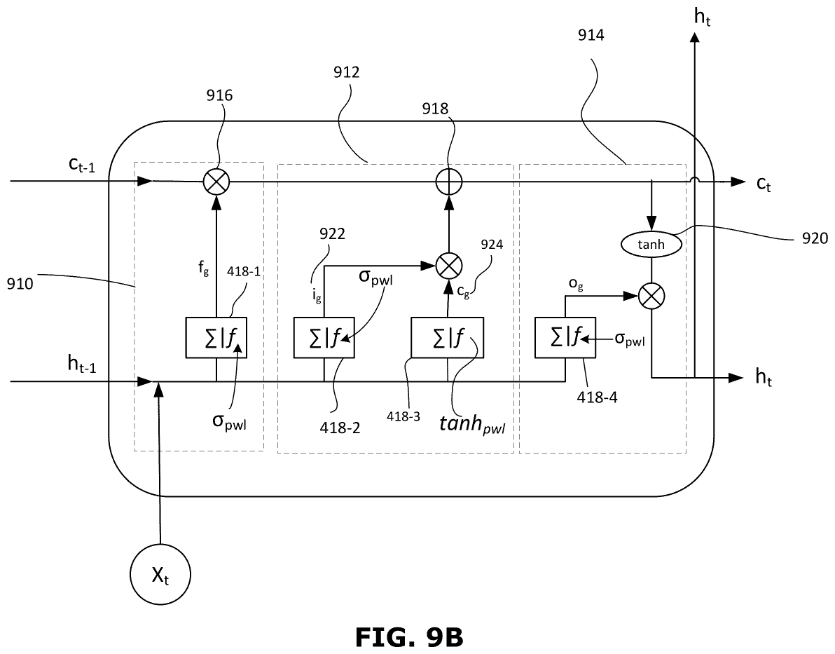

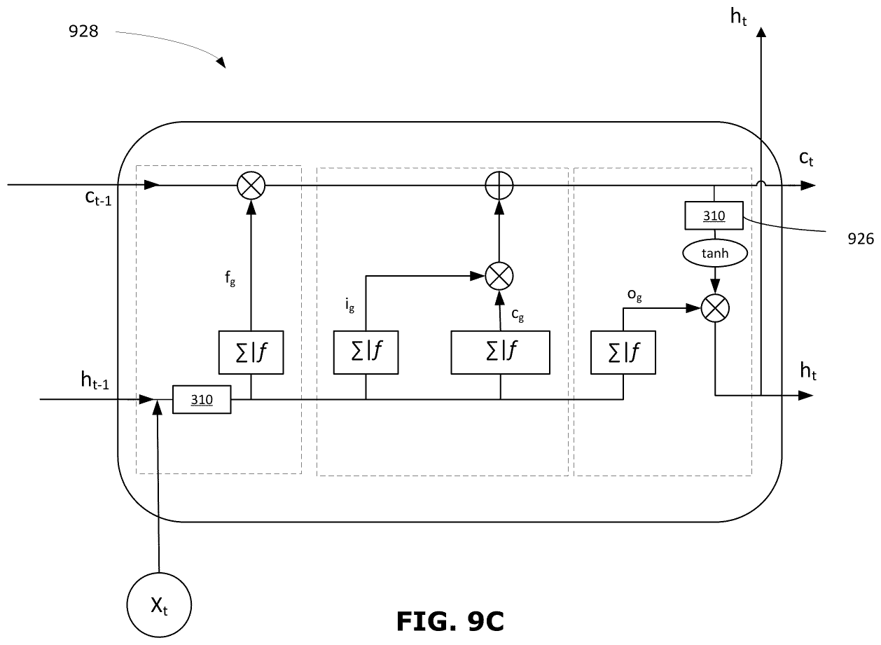

FIG. 9A is a block diagram of a long short-term memory (LSTM) recurrent neural network (RNN) implementing example methods of the present disclosure. RNN is a variant of integer NN 200. In general, RNN models temporal NN input data by using internal memory, and LSTM is a type of RNN. LSTM RNN is described as a chain of LSTM cells 902. Each cell receives input data Xₜ 904, hidden state data hₜ₋₁ 906 from the previous cell, and cell state data cₜ₋₁ 908 from the previous cell, and outputs hidden state hₜ 907 and cell state cₜ 909 to the next cell. Xₜ 904 is the input data of length T with t∈{1,2, . . . , T}. The cell state data (e.g. 908) captures long-term memory of Xₜ 904; it carries and stores information from several previous cells. In other words, the content of a cell state data c (908 and 909) is not overwritten at every cell. The hidden state data h (906 and 907) is capable of storing and carrying information from the previous cell 902 only. The content of a hidden state data h (906 and 907) is overwritten at every cell 902.

FIG. 9B illustrates a trained LSTM cell 902 structure according to example embodiments of the present disclosure. This example's LSTM cell 902 comprises four neurons 302-1, 400-2, 400-3, and 400-4, where neurons 302-1, 400-2, and 400-4 implement piecewise linear activation functions of sigmoid functions (σ_{pwl}) and neuron 302-3 implements a piecewise linear activation function of a tanh nonlinear activation function (tanh_{pwl}). The LSTM cell 902 also comprises three gates: forget gate 910, input gate 912, and output gate 914. These gates are responsible for the flow of information within and out of the LSTM cell 902. Each gate (910, 912, and 914) has at least one neuron (302-1, 302-2, 302-3, or 302-4) and at least one pointwise operation. The pointwise operations may be a multiplication operation, one of which is labelled at 916, or an addition operation 918.

The forget gate 910 is responsible for weighing the cell state input data (cₜ₋₁) 908 from the previous cell using a current input data (Xₜ) 904 and the previous cell's hidden state data (hₜ₋₁) 906. The forget gate 910 includes a neuron 302-1 with a piecewise linear activation function of a sigmoid function, σ_{pwl}, which outputs a value between 0 and 1 for each value of Xₜ 904. Similar to equation (4) described above, equation (9) computes the output f_{g} of the forget gate 910.

f_{g}=σ_{pwl}(XₜW_{fx}+hₜ₋₁W_{fh}) (9)

where Xₜ 904 is the input data, W_{fx} is a weight matrix multiplied with the input data Xₜ 904, hₜ₋₁ 906 is the previous hidden state, W_{fh} is a weight matrix multiplied with hₜ₋₁ 906. All values including Xₜ 904, W_{fx}, W_{fh} and hₜ₋₁ 906 may be quantized with quantizer 404-2 of FIG. 4 (not shown in FIG. 9B). The function σ_{pwl} is a piecewise linear activation function of the sigmoid function implemented by the activation function 308 of neuron 302-1.

The input gate 912 has two neurons 302-2 and 400-3, generating values for input gate i_{g} 922 and candidate gate c_{g} 924. The first neuron 302-2 implements a piecewise linear activation function 308 of a sigmoid function, σ_{pwl}, and the second neuron 302-3 implements a piecewise linear activation function 308 of a tanh function, tanh_{pwl}. The input gate 912 also updates the cell state (cₜ) 908. The values of the input gate i_{g} 922 and the candidate c_{g} 924 may be computed using equations (10) and (11) below.

i_{g}=σ_{pwl}(q(XₜWᵢₓ+hₜ₋₁Wᵢₕ)) (10)

c_{g}=tanh_{pwl}(q(XₜW_{cx}+hₜ₋₁W_{ch})) (11)

where Wᵢₓ, W_{cx} are weight matrices multiplied with Xₜ 904 and Wᵢₓ, W_{ch} are weight matrices multiplied with hₜ₋₁ 906, q(⋅) is the quantization operation performed by quantizer 404-2 and computed as in equations (5)-(7) above. The cell state cₜ 909 of the cell 902 may be computed follows.

cₜ=f_{g}×cₜ₋₁+i_{g}×c_{g} (12)

From equation (12), the forget gate 910 is multiplied with the previous cell state data cₜ₋₁ 908. The forget output f_{g} data of the forget gate 910 is in the range of 0 and 1. When making an inference, the forget gate 910 multiplies cₜ₋₁ with a high number (close to 1) to emphasize on relevant values of cₜ₋₁ and multiplies cₜ₋₁ with a small number (close to 0) to de-emphasize less relevant values of cₜ₋₁ 908.

The output gate o_{g} 914 comprises one neuron 302-4 with a piecewise linear activation function of a sigmoid function 308. The output gate o_{g} data of the output gate 914 may be computed as follows.

o_{g}=σ_{pwl}(XₜWₒₓ+hₜ₋₁Wₒₕ) (13)

Where Wₒₓ and Wₒₕ are weight matrices multiplied with Xₜ 904 and hₜ₋₁ 906, respectively. hₜ 907 of the LSTM cell 902 can be computed as follows.

hₜ=o_{g}×tanh_{pwl}(cₜ) (14)

where tanh_{pwl} 920 of equation (14) is a piecewise linear activation function of tanh 308.

FIG. 9C is a block diagram of a trained LSTM cell 902 incorporating a normalizer 210, resulting in a normalized LSTM cell 928, according to example embodiments. The normalizer 210 of FIG. 2 may be used with LSTM. LSTM cell network has four neurons 302-1, 400-2, 400-3, and 400-4, and may include two normalizers 210, one of which is shown at 926. As a result, the normalized LSTM cell 928 can be computed for equations (9)-(11), (13), and (14) to become as in equations (15)-(19) below.

f_{g}=σ_{PWL}(Norm(XₜW_{fx})+Norm(hₜ₋₁W_{fh})) (15)

i_{g}=σ_{PWL}(Norm(XₜWᵢₓ)+Norm(hₜ₋₁Wᵢₕ)) (16)

c_{g}=tanh_{PWL}(Norm(XₜW_{cx})+Norm(hₜ₋₁W_{ch})) (17)

o_{g}=σ_{PWL}(Norm(XₜWₒₓ)+(hₜ₋₁Wₒₕ)) (18)

hₜ=o_{g}×tanh_{pwl}(Norm(cₜ)) (19)

where Norm(x) performs normalization 210 by implementing equations (1)-(3) above.

The integer NN including the piecewise linear activation function generation, normalization, and quantization methods may be carried out by modules, routines, or subroutines of software executed by the processing unit(s) 100. Coding of software for carrying out the steps of the methods is well within the scope of a person of ordinary skill in the art having regard to the described methods for generating the integer NN. These methods such as methods 600 and 700 may contain additional or fewer steps than shown and described, and the steps may be performed in a different order. Computer-readable instructions, executable by the processor(s) of the processing system 100, may be stored in the memory 110 of the processing unit, or a computer-readable medium. It is to be emphasized that the steps of the methods need not be performed in the exact sequence as shown unless otherwise indicated; and likewise, various steps of methods 600 and 700 may be performed in parallel rather than in sequence.

It can be appreciated that the methods of the present disclosure, once implemented, can be performed by the processing unit(s) 100 in a fully-automatic manner, which is convenient for users to use as no manual interaction is needed.

It should be understood by a person skilled in the art that, for the purpose of convenient and brief description, for a detailed working process of the foregoing system, apparatus, and unit, refer to a corresponding process in the foregoing method embodiments, and details are not described herein again.

In the several embodiments described, it should be understood that the disclosed systems and methods may be implemented in other manners. For example, the described system embodiments are merely examples. For example, the quantizer was shown as part of the neuron, but it could be performed at any time and may be more than one time. Also, the normalizer could be placed and performed at different stages to normalize different data. Further, units or components may be combined or integrated into another system, or some features may be ignored or not performed. In addition, the displayed or discussed mutual couplings or direct couplings or communication connections may be implemented by using some interfaces. The indirect couplings or communication connections between the systems or units may be implemented in electronic, mechanical, or other forms.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices, and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The units described as separate parts may or may not be physically separate, and parts displayed as units may or may not be physical units, may be located in one position, or may be distributed on a plurality of network units.

Some or all of the units may be selected according to actual requirements to achieve the objectives of the solutions of the embodiments.

When the functions are implemented in the form of a software functional unit and sold or used as an independent product, the functions may be stored in a computer-readable storage medium. Based on such an understanding, the technical solutions of this disclosure essentially, or the part contributing to the prior art, or some of the technical solutions may be implemented in a form of a software product. The software product is stored in a storage medium and includes several instructions for instructing a computer device (which may be a personal computer, a server, or a network device) to perform all or some of the steps of the methods 600 and 700 described in the embodiments of this application. The foregoing storage medium includes any medium that can store program code, such as a universal serial bus (USB) flash drive, a removable hard disk, a read-only memory (ROM), a random access memory (RAM), a magnetic disk, or an optical disc, among others.

1. A method for generating output of a neuron in an integer neural network comprising:
receiving an input vector comprising a plurality of input values, the plurality of input values being represented using a desired number bits;
multiplying the input vector by a weight vector to obtain products, and summing the products to obtain a first value;
quantizing the first value to generate a quantized value, the quantized value being represented by the desired number of bits;
applying a piecewise linear activation function to the quantized value to obtain a second value, the piecewise linear activation function including a set of linear functions that collectively approximate a nonlinear activation function; and
quantizing the second value to generate the output of the neuron in the integer neural network, the output of the neuron being represented using the desired number of bits.

2. The method of claim 1, wherein the set of linear functions that collectively approximate a nonlinear activation function is generated by:
receiving a desired number of piecewise segments to represent the nonlinear activation function;
generating input data using the desired number of bits;
generating output data by applying the input data to the nonlinear activation function;
quantizing the output data to obtain quantized output data, with each input data and corresponding quantized output data being processed as respective input and output data pair;
iterating until a number of piecewise segments is equal to the desired number of piecewise segments:
determining piecewise segments, each piecewise segment corresponding to a displacement line connecting a first input and output data pair to a subsequent second input and output data pair;
computing a slope of each piecewise segment;
determining two adjacent piecewise segments with a minimum absolute distance between respective slopes; and
removing a shared input and output data pair of the two adjacent piecewise segments with the minimum absolute distance between respective slopes; and
determining a linear function for each remaining piecewise segment, the linear functions of the remaining piecewise segments being the set of linear functions collectively approximating the nonlinear activation function.

3. The method of claim 2, wherein the generated input data comprises a set of all integer values between 0 and 2ⁿ^{_{bits}}−1, wherein n_{bits} is the number of desired bits.

4. The method of claim 1, wherein quantizing the first value and the second value in a range of values between [a, b] is determined by computing:
$$\begin{matrix}{S}_{m} = \frac{b - a}{{2}^{{n}_{bits}} - 1} \\ {Z}_{m} = round ( \frac{- a}{{S}_{m}} ) \\ q ( m ) = round ( \frac{m}{{S}_{m}} + {Z}_{m} )\end{matrix}$$
where m is the first value or the second value, depending on whether the quantization is being determined for the first value or the second value, respectively, round(⋅) is the round-to-nearest integer function, and n_{bits} is the desired number of bits.

5. The method of claim 4, wherein the range of values between [a, b] is determined from a plurality of first values or a plurality of second values of a plurality of neurons in the integer neural network, depending on whether the quantization is determined for the first value or the second value.

6. The method of claim 1, wherein the second value, determined by applying the piecewise linear activation function to the quantized value, is computed by:
$${f}_{p w l} ( x ) = {\sum }_{i = 1}^{N} {b}_{i} + {{a}_{i} ( x - {k}_{i} )}_{+}$$
$$where$$
$${( x - {k}_{i} )}_{+} = \{ \begin{matrix}0 , & if x < {k}_{i} \\ x - {k}_{i} , & if x \geq {k}_{i}\end{matrix}$$
where f_{pwl}(⋅) is the piecewise linear activation function representing the set of linear functions, N is the number of linear functions, each linear function representing respective piecewise segment, aᵢ is a slope, kᵢ is a piecewise linear knot, and bᵢ is an intercept of the i-th piecewise segment.

7. The method of claim 1, wherein the piecewise linear activation function to approximate a nonlinear activation function is generated during training of the integer neural network, wherein training the integer neural network comprises:
training the integer neural network implementing the nonlinear activation function until meeting a first criterion;
approximating the nonlinear activation function with the piecewise linear activation function;
replacing the nonlinear activation function with the piecewise linear activation function; and
fine-tuning the integer neural network implementing the piecewise activation functions until meeting a second criterion.

8. The method of claim 1, further comprising normalizing the first data by computing:
$$\hat{x} = \frac{1}{M A D s t d} ( x - μ )$$
where \hat{x} is a normalized value x, x is the first data, MAD std is the mean absolute deviation approximating a standard deviation of the first data, and μ is a mean value for the first data, MAD std and μ being computed from a plurality of first data using:
$$\begin{matrix}μ = \frac{1}{m} {\sum }_{i = 1}^{m} {x}_{i} \\ MADstd = \frac{1}{m} {\sum }_{i = 1}^{m} \vert {x}_{i} - μ \vert\end{matrix}$$
m is a number of first data in the plurality of first data, and |⋅| is the L1 norm.

9. The method of claim 8, wherein MAD std and μ are computed from a plurality of first data during training of the integer neural network.

10. The method of claim 1, wherein the neuron of the integer neural network is used in a long short-term memory of a recurrent neural network.

11. A system for generating output of a neuron in an integer neural network, comprising:
a processor; and
a memory storing instructions which, when executed by the processor device, cause the system to:
receive an input vector comprising a plurality of input values, the plurality of input values being represented using a desired number bits;
multiply the input vector by a weight vector to obtain products, and summing the products to obtain a first value;
quantize the first value to generate a quantized value, the quantized value being represented by the desired number of bits;
apply a piecewise linear activation function to the quantized value to obtain a second value, the piecewise linear activation function including a set of linear functions that collectively approximate a nonlinear activation function; and
quantize the second value to generate the output of the neuron in the integer neural network, the output of the neuron being represented using the desired number of bits.

12. The system of claim 11, wherein the set of linear functions that collectively approximate a nonlinear activation function is generated by:
receiving a desired number of piecewise segments to represent the nonlinear activation function;
generating input data using the desired number of bits;
generating output data by applying the input data to the nonlinear activation function;
quantizing the output data to obtain quantized output data, with each input data and corresponding quantized output data being processed as respective input and output data pair;
iterating until a number of piecewise segments is equal to the desired number of piecewise segments:
determining piecewise segments, each piecewise segment corresponding to a displacement line connecting a first input and output data pair to a subsequent second input and output data pair;
computing a slope of each piecewise segment;
determining two adjacent piecewise segments with a minimum absolute distance between respective slopes; and
removing a shared input and output data pair of the two adjacent piecewise segments with the minimum absolute distance between respective slopes; and
determining a linear function for each remaining piecewise segment, the linear functions of the remaining piecewise segments being the set of linear functions collectively approximating the nonlinear activation function.

13. The system of claim 12, wherein the generated input data comprises a set of all integer values between 0 and 2ⁿ^{_{bits}}−1, wherein n_{bits} is the number of desired bits.

14. The system of claim 11, wherein quantizing the first value and the second value in a range of values between [a, b] is determined by computing:
$$\begin{matrix}{S}_{m} = \frac{b - a}{{2}^{{n}_{bits}} - 1} \\ {Z}_{m} = round ( \frac{- a}{{S}_{m}} ) \\ q ( m ) = round ( \frac{m}{{S}_{m}} + {Z}_{m} )\end{matrix}$$
where m is the first value or the second value, depending on whether the quantization is being determined for the first value or the second value, respectively, round(⋅) is the round-to-nearest integer function, and n_{bits} is the desired number of bits.

15. The system of claim 14, wherein the range of values between [a, b] is determined from a plurality of first values or a plurality of second values of a plurality of neurons in the integer neural network, depending on whether the quantization is determined for the first value or the second value.

16. The system of claim 11, wherein the second value, determined by applying the piecewise linear activation function to the quantized value, is computed by applying the following equation:
$${f}_{p w l} ( x ) = {\sum }_{i = 1}^{N} {b}_{i} + {{a}_{i} ( x - {k}_{i} )}_{+}$$
$$where$$
$${( x - {k}_{i} )}_{+} = \{ \begin{matrix}0 , & if x < {k}_{i} \\ x - {k}_{i} , & if x \geq {k}_{i}\end{matrix}$$
where f_{pwl}(⋅) is the piecewise linear activation function representing the set of linear functions, N is the number of linear functions, each linear function representing respective piecewise segment, aᵢ is a slope, kᵢ is a piecewise linear knot, and bᵢ is an intercept of the i-th piecewise segment.

17. The system of claim 11, wherein the piecewise linear activation function to approximate a nonlinear activation function is generated during training of the integer neural network, wherein training the integer neural network comprises:
training the integer neural network implementing the nonlinear activation function until meeting a first criterion;
approximating the nonlinear activation function with the piecewise linear activation function;
replacing the nonlinear activation function with the piecewise linear activation function; and
fine-tuning the integer neural network implementing the piecewise activation functions until meeting a second criterion.

18. The system of claim 11, wherein the memory storing instructions which, when executed by the processor device, cause the system to normalize the first data by computing:
$$\hat{x} = \frac{1}{MADstd} ( x - μ )$$
where \hat{x} is a normalized value x, x is the first data, MAD std is the mean absolute deviation approximating a standard deviation of the first data, and μ is a mean value for the first data, MAD std and μ being computed from a plurality of first data as in the following equation:
$$\begin{matrix}μ = \frac{1}{m} {\sum }_{i = 1}^{m} {x}_{i} \\ MADstd = \frac{1}{m} {\sum }_{i = 1}^{m} \vert {x}_{i} - μ \vert\end{matrix}$$
m is a number of first data in the plurality of first data, and |⋅| is the L1 norm.

19. The system of claim 18, wherein MAD std and μ are computed from a plurality of first data during training of the integer neural network.

20. The system of claim 11, wherein the neuron of the integer neural network is used in a long short-term memory of a recurrent neural network.

21. A non-transitory computer-readable medium comprising instructions which, when executed by a processing device of a processing system cause the processing system to:
receive an input vector comprising a plurality of input values, the plurality of input values being represented using a desired number bits;
multiply the input vector by a weight vector to obtain products, and summing the products to obtain a first value;
quantize the first value to generate a quantized value, the quantized value being represented by the desired number of bits;
apply a piecewise linear activation function to the quantized value to obtain a second value, the piecewise linear activation function including a set of linear functions that collectively approximate a nonlinear activation function; and
quantize the second value to generate the output of the neuron in the integer neural network, the output of the neuron being represented using the desired number of bits.
